(19) United States
(12) Patent Application Publication
(10) Pub. No.: US 2022/0147871 A1
(43) Pub. Date: May 12, 2022

(54) METHOD AND SYSTEM FOR QUALITY CONTROL IN INDUSTRIAL MANUFACTURING

(71) Applicants: Ahmed Frikha, München (DE); Denis Krompaß, München (DE); Hans-Georg Köpken, Erlangen (DE)

(72) Inventors: Ahmed Frikha, München (DE); Denis Krompaß, München (DE); Hans-Georg Köpken, Erlangen (DE)

(21) Appl. No.: 17/436,909

(22) PCT Filed: Mar. 4, 2020
(86) PCT No.: PCT/EP2020/055723

§ 371 Date: Sep. 7, 2021

(30) Foreign Application Priority Data
Mar. 7, 2019 (EP) 19161325.6

(51) Int. Cl. G06N 20/00; G05B 19/418

(52) U.S. Cl. CPC G06N 20/00; G05B 19/41875; G05B 2219/32193; G05B 2219/32177; G05B 2219/32186; G05B 19/41865

(57) ABSTRACT

A method for quality control in industrial manufacturing for one or more production processes for producing at least one workpiece and/or product includes creating a learning model for at least one production process for the at least one workpiece and/or product. The learning model is trained and initialized using a meta-learning algorithm, and the learning model is calibrated using normalized data of the at least one production process for the at least one workpiece and/or product. Currently generated data of the at least one production process for at least one currently produced workpiece/product is forwarded to the learning model. The data is generated by sensors. The learning model compares the currently generated data with the normalized data and finds deviations. The learning model scales the deviations between the currently generated data and the normalized data, and the learning model communicates presence of an anomaly for the currently produced workpiece/product.

This application is the National Stage of International Application No. PCT/EP2020/055723, filed Mar. 4, 2020, which claims the benefit of European Patent Application No. EP 19161325.6, filed Mar. 7, 2019. The entire contents of these documents are hereby incorporated herein by reference.

### BACKGROUND

The present embodiments relate to a method and system for quality control in industrial manufacturing for one or more production processes for producing at least one workpiece and/or product.

Monitoring of the quality of ongoing production in order to provide and provide robust product quality for customers is critical to the success of any manufacturer. Shortcomings in the quality control are therefore not only expensive but may also permanently damage the reputation of a manufacturer. For example, in mass production, however, it is almost impossible to perform comprehensive quality control for every product delivered to the customer.

Quality control is therefore frequently performed on two levels. On the first level, rather superficial quality control is performed, often by the machine operator himself, in order to cover the entire production run, but with poor accuracy. On the second level, in-depth quality control is performed by trained personnel in order to achieve a high level of accuracy, but only for selected single items from a production run. The number of single items examined and the time of an inspection are frequently based on empirical values for a product, the machines used, and the material used. Although this approach has been a tried and tested practice for decades, it has inadequacies, for example, because the inspection on the second level only gives rise to knowledge and experience of the small selection of inspected single items. However, it is assumed that the deficiencies found in the selection of single items will occur in the entire production run since the last quality control performed. When defects are found in a selection of single items, therefore, either all of the single items in a production run are examined or, something that is often less expensive, the entire production run is disposed of as rejects.

In addition, in-depth quality control on the second level frequently takes place only after customer complaints and is therefore reactive. Moreover, the current system of quality control is based on the assumption that defects found for a single item that was produced in a mass production installation apply to the entire run of a production and do not just occur in the single item. Further, the quality control itself is also not of a uniform quality, since quality control is often dependent on the level of training and the daily form of the personnel employed.

Modern machine tools are equipped with a number of sensors that monitor the machine and machining state during production. Additionally, there is an increasing trend to store and process measured data in order to develop new opportunities for optimization and a deeper understanding of the underlying method acts using in-depth data analysis. Well-trained experts are able, on account of a deep understanding of a respective domain and the processes taking place there, and using new software tools, to identify details in the production process for a product and/or workpiece in a manner that was not possible previously. Based on the quality control, these experts may use the data and detailed insights into the mechanisms of the production processes to develop perfectly suited software-controlled solutions that detect defects in the individual workpieces almost in real time and/or optimize the respective single process and/or entire process. However, software solutions customized to such a degree are often very complex and therefore costly and time-consuming, and frequently require the use of optical sensors that are often rather expensive. There is a need to improve the quality control in production installations using automation techniques.

Scalable, automated defect detection during the production/manufacture of a workpiece and/or product is the first step toward fully automatic, data-controlled quality control in factories and production installations. Often, however, it is not possible to collect sufficient data representing the entire variety of machining processes for producing workpieces and products, since the collected data relate to the respective manufacturing site, the machine type used, and the respective NC control only very specifically. One approach to a solution is to develop bespoke IT solutions for every possible scenario until the IT solutions developed deliver satisfactory results. The solutions include the collection and identification of the data for each process step and also a test phase and an error phase. Such an approach is very time-consuming and costly, however. Further, it may be assumed that a mature manufacturing process provides a large amount of workpieces of sufficient quality and defective workpieces are rather the exception.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method and a system for quality control, for example, in industrial manufacturing and production for one or more production processes for producing at least one workpiece and/or product that are distinguished by high reliability and safety and are also inexpensive in the implementation phase and during manufacturing operation are provided.

According to a first aspect, the present embodiments relate to a method for quality control in industrial manufacturing for one or more production processes for a workpiece and/or product. The method includes creating a learning model for at least one production process for the workpiece and/or product, training and initializing the learning model using a meta-learning algorithm, and calibrating the learning model using normalized data of the at least one production process for the at least one workpiece and/or product. Currently generated data of the at least one production process for at least one currently produced workpiece/product is forwarded to the learning model. The data is generated by sensors. The learning model compares the currently generated data with the normalized data and finds deviations, and the learning model scales the deviations between the currently generated data and the normalized data. The learning model communicates the presence of an anomaly for the currently produced workpiece/product.

In a further development, the learning model is in the form of a deep neural network, since only little systematic solution knowledge is available for detecting defective workpieces and a deep neural network having multiple layers is suitable for processing a large amount of sometimes imprecise input information to produce a specific result.

In one embodiment, the meta-learning algorithm is in the form of an agnostic meta-learning algorithm that trains the learning model using a gradient method.

In another configuration, a normalized mean value of a stipulated measured variable for a workpiece and/or product and/or production process is defined as the basis for calculating a deviation.

In one embodiment, the currently generated data has a data identifier (e.g., label). The current generated data may therefore be used for supervised training of a learning model.

In another configuration, the sensors use nonoptical methods for data generation.

In one embodiment, an anomaly is found if the deviation is above or below a stipulated limit value.

According to a second aspect, the present embodiments relate to a system for quality control in industrial manufacturing for one or more production processes for producing at least one workpiece and/or product. The system includes a learning model for at least one production process for the workpiece and/or product. The learning model is configured to be trained and initialized by a meta-learning algorithm, and the learning model is configured to be calibrated using normalized data of the at least one production process for the at least one workpiece and/or product. One or more sensors are configured to generate current data of a production process for a currently produced workpiece and to forward the data to the learning model. The learning model is configured to compare the currently generated data with the normalized data, to find deviations, and to scale the deviations between the currently generated data and the normalized data. The learning model is configured to communicate the presence of an anomaly for the currently produced workpiece/product.

In a further development, the learning model is in the form of a deep neural network.

In one embodiment, the meta-learning algorithm is in the form of an agnostic meta-learning algorithm that trains the learning model using a gradient method.

In a configuration, a normalized mean value of a stipulated measured variable for a workpiece and/or product and/or production process is defined as the basis for calculating a deviation.

In another configuration, the currently generated data has a data identifier (e.g., label).

In one embodiment, the sensors use nonoptical methods for data generation.

In another configuration, an anomaly is found if the deviation is above or below a stipulated limit value.

According to a third aspect, the present embodiments relate to a computer program product containing one or more executable computer codes (e.g., instructions) for performing the method of one or more of the present embodiments.

### BRIEF DESCRIPTION OF THE DRAWINGS

FIG. 1 shows a block diagram to explain an embodiment detail of a system;

FIG. 2 shows a flowchart to explain a method according to an embodiment; and

FIG. 3 shows a schematic depiction of a computer program product according to an embodiment.

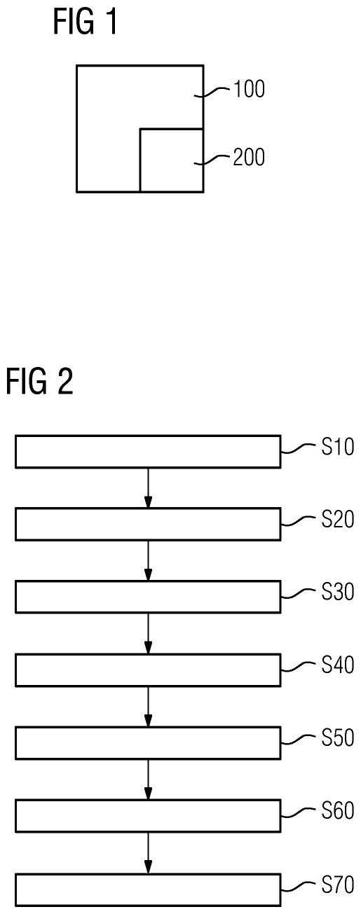

### DETAILED DESCRIPTION

Additional features, aspects and advantages of the exemplary embodiments will become apparent from the detailed description.

According to the present embodiments, a deep neural learning model (deep learning model) 100 is used to detect defects in workpieces in a production run. An example of such a learning model 100 is a convolutional neural network. A deep learning model 100 denotes a class of optimization methods for artificial neural networks that have multiple intermediate layers (e.g., hidden layers) between an input layer and an output layer and, as a result, have a comprehensive internal structure. Such a learning model 100 is optimized for fast adaptation to a new target problem, even if only few input data is available from a normal production and/or machining process. The learning model may be programmed by frameworks such as, for example, TensorFlow or PyTorch.

For training and calibrating the learning model 100, an agnostic meta-learning algorithm 200 is used according to the present embodiments, as described, for example, by Chelsea Finn et al. (Chelsea Finn, Pieter Abbeel, Sergey Levine: Model-Agnostic Meta-Learning for Fast Adaption of Deep Networks, 18 Jul. 2017). The agnostic meta-learning algorithm 200 is capable of training the learning model 100 by a gradient method in order to perform initialization of the parameterized deep learning model 100.

The data conditioning, the model training, and the model application for an instance of application are described in more detail below. The detection of anomalies and/or faults during the production and/or machining of workpieces and/or other products is based exclusively on sensor signal data generated by data capture devices and sensors in a production installation.

As a result of the training by the agnostic meta-learning algorithm 200, the deep learning model 100 is capable of adapting to a new manufacturing process after the training phase and of using only data from workpieces that are of sufficiently good quality. Ideally, the learning model 100 achieves the required adaptation to a new manufacturing process cycle simply by virtue of the data generated for the test runs during the calibration phase.

According to the present embodiments, the learning model 100 is calibrated only based on data relating to normal states of a workpiece and/or product (e.g., normal state data) and when processing, for example, nonvisual sensor data with the aim of anomaly detection in manufacturing processes.

The data conditioning for training the learning model 100 is explained in more detail below. In order to train the learning model 100, a sufficient number of sensors are to be provided in a manufacturing installation. By way of example, these sensors may measure torques of various axles in a milling machine and may control deviations. Additionally, data from a sufficient number of workpieces and machining processes are to be provided. Further, a data identifier (e.g., label) that appropriately marks the data that indicates anomalies may be provided.

In one embodiment, an expert undertakes identification of the data using data identifiers (e.g., labeling) with an appropriate reference. An example that will be mentioned is torque measurements for a milling spindle. By way of example, the control errors in the Z-axis of 100 tools and for 8 different processing processes are examined. The processing processes include various rough machining processes (e.g., the cutting of a pocket into the workpiece) and refining processes such as smoothing the top surface of the workpiece.

As a preprocessing act of the method according to the present embodiments, the various data signals generated for each process act are captured according to deviation from a stipulated standard value on a scale, and are thus scaled. For some data signals, it may also be appropriate to subtract the data value of the data signal of the representative data for the normal machining (e.g., standard machining) from the newly generated data signals in order to be able to detect the deviation more distinctly. This is appropriate, for example, if the value of the deviation is small in comparison with the value of the data signal. The deviations from a normalized mean value of a stipulated measured variable are therefore captured for a workpiece and/or product.

The learning model 100 is trained by the agnostic meta-learning algorithm 200. The algorithm 200 for training the model may be represented as pseudocode as follows:

| | |
|---|---|
| 1. | Preprocess the data. |
| 2. | Randomly initialize the learning model parameters θ. |
| 3. | while not converging |
| 4. | Take a set of n processes Pᵢ ~ p (P) |
| 5. | For every Pᵢ, the following should be performed: |
| 6. | Take k training examples for the normal machining behavior from the |

process Pᵢ.

| | |
|---|---|
| 7. | Rate the performance of the anomaly detection of the learning model |

on the basis of these examples.

| | |
|---|---|
| 8. | Update the learning model parameters θ according to θ′ using a |

gradient method.

| | |
|---|---|
| 9. | End for |
| 10. | Take n x k training examples for the detection of anomalies from the taken set |

of n processes.

| | |
|---|---|
| 11. | Update the learning model parameters θ with reference to the error that arose |

from the model parameterized by θ′ on account of the gradient method.

| | |
|---|---|
| 12. | End while |

In the training phase, the learning model 100 is optimized for the instance of application. If the learning model 100 is used for detecting anomalies for a new workpiece and/or for a new machining process, it is assumed according to the present embodiments that sufficient data based on the normal machining have been captured during the calibration phase of the machine and the process (e.g., as a result of the making of test workpieces). According to the present embodiments, the method acts of the inner training loop of the meta-learning algorithm 200 are used to quickly adapt the learning model parameters 100 to the new situation (e.g., new workpiece and/or new manufacturing process):

1. Preprocess the calibration data.
2. Initialize the learning model 100 using the parameters θ found during the learning model training.
3. Take k training examples for the normal machining behavior after the new process Pᵢ.
4. Update the learning model parameters θ to θ′ using the same configured gradient method as was used during the training.

If the learning model 100 changes to the production mode, the calibrated learning model 100 is used in order to find anomalies for the data currently generated by the sensors (e.g., live data) for a workpiece and/or product during a specific production process:

1. Preprocess the currently generated data.
2. Initialize the learning model 100 using the parameters e′ found during the model calibration.
3. Predict anomaly probabilities for the currently generated data using the learning model 100.

The learning model 100 is trained under similar conditions to learning models that would arise in a real production scenario. In one embodiment, the learning model 100 is trained in a laboratory environment using a sufficient volume of data with a data identifier from different machining processes and/or production steps, such as, for example, the use of different machines. The agnostic meta-learning algorithm 200 allows the learning model 100 to quickly adapt itself to a new production environment and/or production processes.

In one embodiment, a process step and a limited dataset from the normal manufacturing and machining processes for manufacturing workpieces are used in each training iteration in order to calibrate the learning model 100. The learning model 100 is therefore capable of finding anomalies for individual workpieces from sensor signal data that is generated during a new manufacturing process and was not used during the training phase of the learning model 100. When the learning model 100 is used during manufacture, anomalies that are below or above a stipulated limit value are then detected quickly and efficiently for each individual workpiece for which current data is generated.

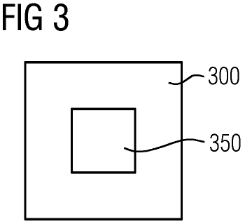

FIG. 3 shows a flowchart for a method according to an embodiment for quality control in industrial manufacturing.

In act S10, a learning model 100 is created for one or more production processes for at least one workpiece and/or product.

In act S20, the learning model 100 is trained and initialized using a meta-learning algorithm 200.

In act S30, the learning model 100 is calibrated using normalized data of at least one production process for the at least one workpiece and/or product.

In act S40, currently generated data of the at least one production process for at least one currently produced workpiece/product is forwarded to the learning model (100). The data is generated by sensors.

In act S50, the learning model 100 compares the currently generated data with the normalized data and finds deviations.

In act S60, the learning model scales the deviations between the currently generated data and the normalized data.

In act S70, the learning model communicates the presence of an anomaly for the currently produced workpiece/product.

FIG. 3 schematically depicts a computer program product 300 containing one or more executable computer codes 350 for performing the method according to the first aspect of the present embodiments.

The present embodiments may be used very inexpensively because the calibration complexity for the learning model 100 for a new manufacturing process is low and may easily be implemented. Further, the present embodiments allow guided quality control as compared with planned quality control in industrial manufacturing. The period to react to defects while production is ongoing may be significantly shortened, and the reject rate for products may be substantially reduced. The present embodiments may be used in the case of large quantities and during mass production, because each workpiece may be inspected using high-resolution data. The present embodiments may be used to deal with the unique features that any production process, any machine, and any site has.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for quality control in industrial manufacturing for one or more production processes for producing at least one workpiece, product, or workpiece and product, the method comprising:
creating a learning model for at least one production process for a workpiece, product, or workpiece and product;
training and initializing the learning model using a meta-learning algorithm;
calibrating the learning model using normalized data of the at least one production process for the workpiece, product, or workpiece and product;
forwarding currently generated data of the at least one production process for at least one currently produced workpiece/product to the learning model, the currently generated data being generated by sensors;
comparing, by the learning model, the currently generated data with the normalized data, such that deviations are found;
scaling, by the learning model, the deviations between the currently generated data and the normalized data; and
communicating, by the learning model, presence of an anomaly for the currently produced workpiece/product.

2. The method of claim 1, wherein the learning model is in the form of a deep neural network.

3. The method of claim 1, wherein the meta-learning algorithm is an agnostic meta-learning algorithm that trains the learning model using a gradient method.

4. The method of claim 1, wherein a normalized mean value of a stipulated measured variable for a workpiece, product, or workpiece and product, production process, or a combination thereof is defined as the basis for calculating a deviation of the deviations.

5. The method of claim 1, wherein the currently generated data has a data identifier.

6. The method of claim 1, wherein the sensors use nonoptical methods for data generation.

7. The method of claim 1, wherein the anomaly is found when a deviation of the deviations is above or below a stipulated limit value.

8. A system for quality control in industrial manufacturing for one or more production processes for producing at least one workpiece, product, or workpiece and product, the system comprising:
a learning model for at least one production process for a workpiece, product, or workpiece and product, the learning model being configured to be trained and initialized by a meta-learning algorithm, and being configured to be calibrated using normalized data of the at least one production process for the workpiece, product, or workpiece and product; and
one or more sensors configured to generate current data of a production process for a currently produced workpiece and to forward the currently generated data to the learning model,
wherein the learning model is configured to:
compare the currently generated data with the normalized data;
find deviations;
scale the deviations between the currently generated data and the normalized data; and
communicate presence of an anomaly for the currently produced workpiece/product.

9. The system of claim 8, wherein the learning model is in the form of a deep neural network.

10. The system of claim 8, wherein the meta-learning algorithm is in the form of an agnostic meta-learning algorithm that trains the learning model by a gradient method.

11. The system of claim 8, wherein a normalized mean value of a stipulated measured variable for a workpiece, product, or workpiece and product, production process, or a combination thereof is defined as the basis for calculation of a deviation of the deviations.

12. The system of claim 8, wherein the currently generated data has a data identifier.

13. The system of claim 8, wherein the sensors are configured to use nonoptical methods for data generation.

14. The system of claim 8, wherein the anomaly is found when a deviation of the deviations is above or below a stipulated limit value.

15. (canceled)

16. In a non-transitory computer-readable storage medium that stores instructions executable by one or more processors for quality control in industrial manufacturing for one or more production processes for producing at least one workpiece, product, or workpiece and product, the instructions comprising:
creating a learning model for at least one production process for a workpiece, product, or workpiece and product;
training and initializing the learning model using a meta-learning algorithm;
calibrating the learning model using normalized data of the at least one production process for the workpiece, product, or workpiece and product;
forwarding currently generated data of the at least one production process for at least one currently produced workpiece/product to the learning model, the currently generated data being generated by sensors;
comparing, by the learning model, the currently generated data with the normalized data, such that deviations are found;
scaling, by the learning model, the deviations between the currently generated data and the normalized data; and
communicating, by the learning model, presence of an anomaly for the currently produced workpiece/product.
